(19) United States
(12) Patent Application Publication
(10) Pub. No.: US 2025/0040561 A1
(43) Pub. Date: Feb. 6, 2025

(54) FERMENTED BEVERAGE COMPOSITION COMPRISING NUTS, OPTIONALLY SEEDS, AND LEGUME

(71) Applicant: SOCIETE DES PRODUITS NESTLE S.A., Vevey (CH)

(72) Inventors: JOESKA HUSNY, Aarau (CH); SEBASTIEN RADIGUET, Lisieux (FR); GIULIA MARCHESINI, Maracon (CH); MONICA MARTINEZ ERRO, Bern (CH)

(21) Appl. No.: 18/722,807

(22) PCT Filed: Dec. 13, 2022
(86) PCT No.: PCT/EP2022/085492

§ 371 Date: Jun. 21, 2024

(30) Foreign Application Priority Data
Dec. 21, 2021 (EP) 21216223.4

(51) Int. Cl. A23C 11/10; A23C 9/127

(52) U.S. Cl. CPC A23C 11/106; A23C 9/127

(57) ABSTRACT

The invention relates to a fermented plant-based beverage composition comprising nuts, optionally seeds, and legumes, the nuts, optionally seeds and legumes present 25 to 50 wt. % of the total solids in the beverage composition, at least 50 wt. % of the nuts are roasted, preferably least 50 wt. % of the nuts and optionally seeds are roasted, and at least 50 wt. % of the nuts and seeds are milled wholesome nuts and seeds, and wherein the beverage composition being fermented with strains comprising lactic acid bacteria 1) Lactobacillus delbrueckii subsp. bulgaricus and 2) Streptococcus thermophilus, and having a pH of 4.0 to 5.5, preferably a pH of 4.2-4.5. The invention also relates to a process of making such a beverage.

### FIELD OF THE INVENTION

The present invention relates to a liquid fermented beverage composition. In particular, the present invention relates to a fermented beverage composition comprising nuts, seeds and legumes. The invention also relates to a process for making such a product.

### BACKGROUND

Certain consumers wish to consume less milk or do not want to consume milk at all, for example, because of its animal origin, due to lactose intolerance or due to dairy allergies. They may also see potential environmental sustainability issues.

Consequently, consumers seek alternatives to milk. Alternatives to milk do exist and the dairy alternatives market is growing by 11% each year and finding an alternative with good nutrition and taste will be a major advantage in this competitive field.

CA2982280 discloses a method of producing a milk alternative, without necessarily adding a gum or emulsifier or starch, using chickpeas and/or other whole legumes or lentils (regular, sprouted or fermented), using pea protein, chickpea protein and/or a combination of plant-based protein (regular, sprouted or fermented), using flax seed oil and/or other vegetable oil, through high rotation mixing, heat and pressure, producing a very smooth mouthfeel.

Pea protein containing milk alternatives are commercially available.

However, consumers increasingly search for liquid food compositions that can be used as dairy alternatives that have an excellent nutritional value and a pleasant taste profile. In particular, there is a need for such liquid food compositions that are source of protein, and fiber.

In particular, the inclusion of fiber while maintaining a pleasant taste and texture profile appears to be difficult. In accordance with this US20130196028A1 discloses a method of making a chickpea soluble fraction, but which includes the removal of dietary fiber by filtration.

Also, if milk protein is replaced by plant protein sources, this often results in an unpleasant taste, and the composition can be perceived as bitter and/or astringent.

It would therefore be desirable to provide a liquid food composition that can be used as milk alternative, contains fiber and that has a good nutritional profile and taste profile.

A technical challenge is current commercial plant-based yoghurt and drinks are known to be thin in texture and not creamy. Additionally, commercial plant-based often uses starches and hydrocolloids (gums) for texturization purpose which is not consumer friendly.

Furthermore, there is a need for milk alternatives which are stable during several weeks of storage without formation of separation e.g., gel formation.

Any reference to prior art documents in this specification is not to be considered an admission that such prior art is widely known or forms part of the common general knowledge in the field.

### OBJECT OF THE INVENTION

The object of the present invention is it to improve the state of the art and in particular to provide a liquid food composition that can be used as dairy alternative. Furthermore, the object of the invention is to provide such product which is without bitter and/or astringent taste that can be associated with plant-based products and has an improved mouthfeel.

### SUMMARY OF THE INVENTION

The present invention provides an improvement on taste, mouthfeel, physical stability and viscosity of a plant-based fermented products from nuts, seeds and legumes.

In a first aspect, the invention relates to a fermented plant-based beverage composition comprising nuts, optionally seeds, and legumes,
the nuts, optionally seeds and legumes present 25 to 50 wt. % of the total solids in the beverage composition,
at least 50 wt. % of the nuts are roasted, preferably least 50 wt. % of the nuts and optionally seeds are roasted, and
at least 50 wt. % of the nuts and optionally seeds are milled wholesome nuts and seeds, and wherein
the beverage composition being fermented with strains comprising lactic acid bacteria 1) Lactobacillus delbrueckii subsp. bulgaricus and 2) Streptococcus thermophilus, and having a pH of 4.0 to 5.5, preferably a pH of 4.2-4.5.

Preferably, the fermented plant-based beverage is a dairy-free beverage.

It has been found that a combination of roasted nuts and seeds of different roasting conditions of nuts and seeds not only boost flavour of the fermented beverage product but also provide a creamy taste and texture to the product. Furthermore, flavour is also obtained from lactic acid fermentation. In a preferred embodiment of the fermented product according to the invention is done with lactic acid bacteria comprising Lactobacillus delbrueckii subsp. bulgaricus, Streptococcus thermophilus, Lactobacillus plantarum, Lactobacillus acidophilus and Bifidobacterium lactis, in particular comprising L. bulgaricus, and S. thermophilus.

The fermented beverage according to the invention is devoid of bitter and/or astringent taste that can be associated with plant-based products. Furthermore, the wholesome ingredients such as nuts and seeds as they are naturally rich in fibers and healthy fats.

In a second aspect, the invention relates to a process for preparing a fermented plant-based beverage composition, the process comprises the steps:
a) providing nuts, optionally seeds, and legume, wherein at least 50 wt. % of the nuts and optionally seeds are wholesome nuts and seeds, and
b) roasting at least 50 wt. % of the nuts, preferably at least 50 wt. % of the nuts and optionally seeds, to a moisture content below 2 wt. % water,
c) reducing particles size of the nuts and optionally seeds to a resultant particle size below 70 micron, preferably below 50 micron,
d) forming a suspension with 10-15 total solids (TS) % comprising the nuts and optionally seeds, and legumes,
e) homogenizing the suspension at a pressure 100-300 bar,
f) heat treating the suspension at a temperature of 70 to 100° C. for a period 30 sec to 6 min,
g) inoculating the beverage composition with strains comprising lactic acid bacteria 1) Lactobacillus delbrueckii subsp. bulgaricus and 2) Streptococcus thermophilus, and 2) fermenting the beverage composition until reaching a pH from 4.0 to 5.5, preferably 4.2 to 4.5.

The obtained fermented beverage composition is without astringency and bitterness. In one embodiment of the invention the seeds are not optional.

In a preferred embodiment of the invention the homogenizing is done with one step homogenisation, preferably upstream homogenisation relative to the heat treatment in order to achieve the combination of desired effects of low particle size distribution and high viscosity for improved texture and mouthfeel.

Furthermore, it has been found that the addition of legumes, for example soy, to nuts and seeds beverage composition preserves the desired nutty and cereal flavour while reducing off-flavours.

The lactic acid bacteria used in the method according to the invention are 1) Lactobacillus delbrueckii subsp. bulgaricus and 2) Streptococcus thermophilus, preferably L. bulgaricus and S. thermophilus.

Nuts and seeds based non-dairy fermented drink according to the invention is characterised by an acidification curve that shows rapid acidification during the first 2 hours of the fermentation process and reaching pH between 4.2-4.7 after 3-6 hours, see FIG. 1. More preferably with a pH between 4.2-4.5.

During the fermentation step, the starter culture converts the fermentable sugar into acids. The formation of acids promotes the formation of a gel with a sufficient consistency by the coagulation of proteins into a protein network.

### BRIEF DESCRIPTION OF THE DRAWINGS

FIG. 1 shows acidification curves of different plant-based beverages during fermentation with selected strains L. bulgaricus and S. thermophilus.

FIG. 2 shows a process flow diagram for the production of a shelf-stable fermented plant-based product according to the invention.

FIG. 3 shows the effect of different strains on the PSD of fermented plant-based beverages.

FIG. 4 shows the effect of different strains on the viscosity of fermented plant-based beverages.

FIG. 5 shows the sensory 11-point scale used to rate the different attributes in the sensory monadic profiling of fermented plant-based beverages containing different proteins from legumes.

FIG. 6 shows a Duncan chart of the sensory monadic profiling of fermented plant-based beverages containing different proteins from legumes.

FIG. 7 shows a process flow diagram for the production of a nut paste from unshelled walnut kernels.

FIG. 8 shows the PSD of nut pastes produced with different roasting and milling conditions from unshelled walnut kernels.

FIG. 9 shows the effect of homogenization pressure on the PSD of a fermented plant-based beverage.

FIG. 10 shows the effect of homogenization pressure on the viscosity of a fermented plant-based beverage.

FIG. 11 shows a process flow diagram with additional homogenization conditions for the optimization of the production of a shelf-stable fermented plant-based product according to the invention.

FIG. 12 shows the effect of different homogenization conditions on the PSD of a fermented plant-based beverage.

FIG. 13 shows the effect of different homogenization conditions on the viscosity of a fermented plant-based beverage.

FIG. 14 shows the oxygen consumption measurement after 20 hours oxidation by Rapidoxy in fermented plant-based beverages.

FIG. 15 shows the 6-point scale used in the sensory monadic profiling of a fermented plant-based beverage containing different antioxidant systems during shelf-life.

FIG. 16 shows the sensory monadic profiling of a fermented plant-based beverage containing different antioxidant systems during shelf-life.

### DETAILED DESCRIPTION OF THE INVENTION

The invention relates to a fermented plant-based beverage composition comprising nuts, seeds, and legumes, nuts, seeds and legumes present 25 to 50 wt. % of the total solids in the beverage composition, at least 50 wt. % of the nuts are roasted, preferably least 50 wt. % of the nuts and seeds are roasted, and at least 50 wt. % of the nuts and seeds are milled wholesome nuts and seeds, and wherein the beverage composition being fermented with strains comprising lactic acid bacteria 1) Lactobacillus delbrueckii subsp. bulgaricus and 2) Streptococcus thermophilus, and having a pH of 4.0 to 5.5, preferably a pH of 4.2-4.5.

In the present context “wholesome” nuts are nuts wherein the skin has not been removed. Furthermore, in the present context “wholesome” nuts are different from skinned and blanched nuts. The “wholesome” nuts have not been refined and the oil therein is intact.

Further, in the present context “roasted nuts” are nuts that have been subject to a heat treatment of at least 100° C. for a time sufficient to change the flavour profile of the nuts e.g for a period of 10-90 min.

It is preferred that the beverage composition according to the invention comprising 5-20 wt. % total solids (TS), preferably 8-20 wt. %, more preferably 8-15 wt. % total solids (TS). In an alternative embodiment the beverage composition comprises 15-20 wt. % total solids (TS).

Advantageously, the fermented beverage composition according to the invention comprises 0.5-3 wt. % legumes. Preferably, the legumes are selected from the group consisting of pea, soy, faba, chickpea or a combination thereof, wherein the legumes are preferably in the form of protein isolates or concentrates, more preferably with a protein content in the range of 60-99 wt. %.

In a preferred embodiment according to the invention, the nuts are present in amounts of 1 to 6 wt. % in the beverage composition. In another preferred embodiment according to the invention, 0.5-5 wt. % seeds are present in the beverage composition. Advantageously, the beverage composition according to the invention comprises 0.5-5 wt. % cereal, the cereal preferably being oat. More preferably, the beverage composition comprises 1 to 6 wt. % nuts, 0.5-5 wt. % seeds and 0.5-5 wt. % cereal. An alternative preferred embodiment of the beverage composition according to the invention comprises 1 to 6 wt. % nuts, and 0.5-5 wt. % cereal, the cereal preferably being oat. In alternative preferred embodiments mentioned in this paragraph the nuts are present in amounts of 2 to 6 wt. %.

According to the invention, the beverage composition may comprise 0.2-5 wt. % dietary fiber, preferably 0.4-5 wt. % dietary fiber. Furthermore, the beverage composition according to the invention may comprise 2-6 wt. % added sugar, preferably 2.5-4.0 wt. % added sugar.

The oleaginous plants, which can be used in the process of the invention are preferably selected from the group consisting of peanut, soybean, rapeseed, sunflower, sesame, neem, cotton, palm, coconut, shea, castor bean, corn, nuts, almonds, hazelnuts, coconut, pistachios, walnut, cashew, seeds of grapes or a combination thereof.

The term “oleaginous plant” includes the part(s) of the plant which are used for recovering oil such as, in particular the fruits or the seeds of the plant. Among these oleaginous plants, it is preferred to use nuts and seeds, and more in particular walnut, almond, hazelnut, sunflower seeds and black sesame seeds.

It has been found that the beverage according to the invention may be offered for sale with a packaging claim or combination of packaging claims such as source of protein, source of fiber, source of omega-3, source of vitamin E, that provides a good nutritional profile, and a flavorful and clean taste profile.

Furthermore, for the beverage according to the invention, packaging claim may be made indicating it is a food or beverage that is a “source of protein”, and any claim likely to have the same meaning for the consumer, may be made where at least 12% of the energy value of the food is provided by protein.

Additionally, for the beverage according to the invention, a packaging claim may be made indicating it is a food or beverage that is a “source of fibre”, and any claim likely to have the same meaning for the consumer, may be made where the product contains at least 3 g of fibre per 100 g or at least 1.5 g of fibre per 100 kcal.

Additionally, for the beverage according to the invention, a packaging claim may be made indicating it is a food or beverage that is a “source of vitamins and/or minerals”, and any claim likely to have the same meaning for the consumer, may be made where the product contains at least a significant amount as defined in the Annex to Directive 90/496/EEC or an amount provided for by derogations granted according to Article 6 of Regulation (EC) No 1925/2006 of the European Parliament and of the Council of 20 Dec. 2006 on the addition of vitamins and minerals and of certain other substances to foods.

Additionally, on the beverage product according to the invention, a packaging claim may be made indicating it is a food or beverage that is a “source of omega-3 fatty acids”, and any claim likely to have the same meaning for the consumer, may be made where the product contains at least 0.3 g alpha-linolenic acid per 100 g and per 100 kcal, or at least 40 mg of the sum of eicosapentaenoic acid and docosahexaenoic acid per 100 g and per 100 kcal.

The process according to the invention relates to a process for preparing a fermented plant-based beverage composition, the process comprises the steps:
a) providing nuts, optionally seeds, and legume, wherein at least 50 wt. % of the nuts and optionally seeds are wholesome nuts and seeds, and
b) roasting at least 50 wt. % of the nuts, preferably at least 50 wt. % of the nuts and optionally seeds, to a moisture content below 2 wt. % water,
c) reducing particle size of the nuts and optionally seeds to a resultant particle size below 70 micron, preferably below 50 micron,
d) forming a suspension with 10-15 total solids (TS) % comprising the nuts and optionally seeds, and legumes,
e) homogenizing the suspension at a pressure of 100-300 bar,
f) heat treating the suspension at a temperature of 70 to 100° C. for a period 30 sec to 6 min,
g) inoculating the beverage composition with strains comprising lactic acid bacteria 1) Lactobacillus delbrueckii subsp. bulgaricus and 2) Streptococcus thermophilus, and 2) fermenting the beverage composition until reaching a pH from 4.0 to 5.5, preferably 4.2 to 4.5.

The obtained fermented beverage composition is without astringency and bitterness.

It is preferred that the roasting is done at a temperature between 100-150° C., more preferably at a temperature between 100-120° C. with the final moisture target below 2%. Advantageously, the roasting is done in a two-step roasting process. This provides both flavour optimisation as well as achieving small particle size during milling (below 70 um).

Homogenizing the suspension according to the invention is at a pressure 100-400 bar, preferably 180-300 bar. This reduces the particle size, softens and expands the fibres.

In a preferred embodiment of the invention the homogenizing is done with one step homogenisation, preferably upstream homogenisation in order to achieve the combination of desired effects of low particle size distribution and high viscosity for improved texture and mouthfeel. In particular, this allows that beverage composition is provided with the highest particle size reduction and higher viscosity; both required for enhanced creaminess and mouthfeel without perception of sandiness as well as boosting nutty flavours is obtained.

In one embodiment of the invention, the starter culture comprises additional lactic acid-producing bacteria or the starter culture comprises least one lactic acid-producing bacteria.

The invention also relates to a process wherein the suspension is a beverage composition as claimed.

The reduction of the particle size of the nuts and seeds is preferably done by milling.

Advantageously, this is done by means of a stone mill with the milling gap between 0.01-0.5 mm, preferable 0.03-0.05 mm. This allows the resultant particle size of the nuts and seeds to be below 70 microns, preferably below 50 microns to reduce the perception of sandiness in the plant-based beverage.

The resultant is a paste with particle size below 70 microns, preferably below 50 microns. Particle size below 100 micrometre reduces the perception of sandiness or powderiness in a plant-based beverage.

Furthermore, it has been found that the addition of legumes, for example soy, to nuts and seeds beverage composition preserves the desired nutty and cereal flavour while reducing off-flavours.

The lactic acid bacteria used in the method according to the invention are 1) Lactobacillus delbrueckii subsp. bulgaricus and 2) Streptococcus thermophilus, preferably L. bulgaricus and S. thermophilus.

Inoculating the beverage composition is done with at least one starter culture to obtain an inoculated beverage composition and the beverage composition is fermented preferably at temperature 40-47° C., more preferably 42-45° C., until reaching a pH from 4.2 to 4.7, preferably 4.2 to 4.5 to obtain a fermented beverage composition.

Additionally, hydrocolloids such as pectin can be used in combination with oat flour to complement viscosity and texture to further reduce perception of sandiness and improve mouthfeel.

In a particular preferred embodiment of the invention, the beverage composition comprises oat, preferably in the form of oat flour. The oat is advantageously present in an amount of 12-20 wt. %, more preferably in an amount of 14-17 wt. % dry basis. Furthermore, it is preferred that the beverage composition comprises 1-5 wt. % (dry basis) of pectin.

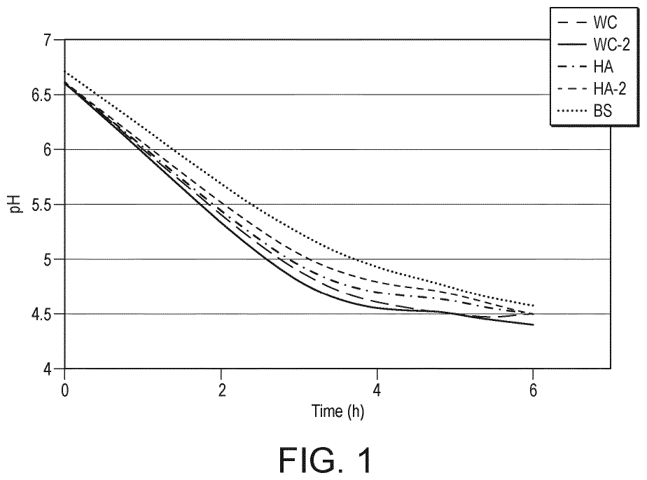

Nuts and seeds based non-dairy fermented drink according to the invention is characterised by an acidification curve that shows rapid acidification during the first 2 hours of the fermentation process and reaching pH between 4.2-4.7 after 3-6 hours, see FIG. 1. More preferably with a pH between 4.2-4.5.

During the fermentation step, the starter culture converts the fermentable sugar into acids. The formation of acids promotes the formation of a gel with a sufficient consistency by the coagulation of proteins into a protein network.

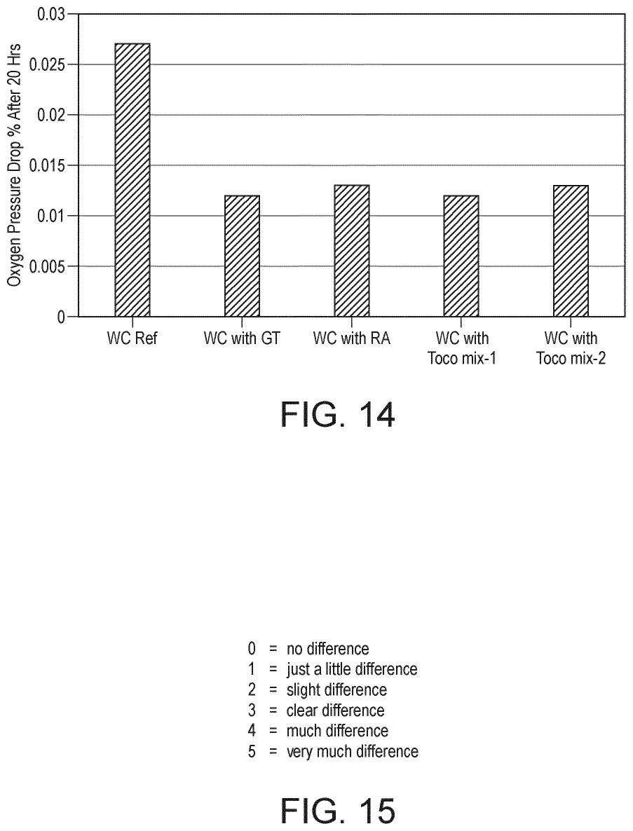

The beverage according to the invention is characterized by high level of unsaturated lipids (0,1-4%). Materials with good oxidative stability was chosen to maintain good taste during shelf life. Good oxidative stability was considered on an induction period (IP) of a maximum of 1200 minutes, measured at 80-100° C. to a defined oxygen pressure drop of 10%. Shelf life can be prolonged by the use of natural oil soluble antioxidants, in particular tocopherols (alpha tocopherols, delta tocopherols, mixed tocopherols) and/or in combination with rosmarinic acid, and green tea extract (FIG. 14).

The beverage according to the invention preferably comprises tocopherols, more preferably mixed tocopherols.

Preferably, the suspension is formed with 10-15% TS comprising a mixture of nuts and legumes, and optionally seeds. The suspension is homogenized, and heat treated.

Usually, the pressure carried out for the homogenisation step is higher than 30 bar, preferably comprised between 100 and 400 bar, more preferably between 200 and 300 bar.

The homogenisation step can be carried out at a temperature comprised between 3° and 80° C., preferably between 4° and 70° C. The homogenisation step usually lasts from 10 min to 2 hours, preferable from 30 to 90 min.

The homogenisation step can be performed in one or several stages, usually two stages. When it is performed in two stages, the first stage can be performed at a first pressure comprised between 100 to 350 bar, preferably between 150 and 300 bar, and the second stage can be performed at a second pressure of 30 to 90 bar, preferably between 35 and 70 bar. The temperature at which each stage is carried out can be the same or different.

Similarly, the duration of each of the stages can be equal or different. The homogenisation step can be carried out using conventional homogenisation devices, in particular a GEA Panda Plus 2000 homogeniser. The conditions of use of the GEA Panda Plus 2000 homogeniser are settled by the manufacturer's recommendations.

After the first heat-treatment step, the process comprises a step of inoculating the heat-treated and homogenized plant-based food composition with at least one starter culture. Especially, the starter culture is substantially free, preferably entirely free from dairy components. Examples of starter culture include Lactobacillus acidophilus, Lactobacillus delbrueckii subsp. bulgaricus, Lactobacillus paracasei, Lactobacillus casei, Lactobacillus johnsonii, Lactobacillus plantarum, Streptococcus thermophilus, Streptococcus lactis, Streptococcus cremoris, Bacillus coagulans, strains from the genus Bifidobacterium and mixtures thereof. Preferably, the starter culture consists of one or more lactic acid bacteria strains. Preferably, the starter culture consists of one or more thermophilic lactic acid bacteria strains. The term “thermophilic lactic acid bacteria strains” refers to lactic acid bacteria strains having an optimal growth at a temperature between 40° C. and 47° C. Most preferably, the starter culture is a combination of L. bulgaricus and S. thermophilus. Especially, L. bulgaricus and S. thermophilus are the two staple strains that are used in dairy yogurts. According to certain regulation, the yogurt denomination is only possible for dairy yogurt containing said two strains as starter cultures.

After the inoculation step, the process according to the invention comprises a step of fermenting inoculated plant-based food composition until reaching a pH from 4.2 to 4.7, preferably 4.2 to 4.5 to obtain a fermented plant-based product e.g. a plant-based yogurt analogue. During the fermentation step, the starter culture converts the fermentable sugar into acids. The formation of acids promotes the formation of a gel with a sufficient consistency by the coagulation of plant proteins into a plant protein network. The consistency of the obtained gel mimics the consistency of standard dairy yogurts. A satisfactory texture is obtained even in the absence of added thickening agents.

After the fermentation of the product an additional heating is carried out at a temperature from 80° C. to 140° C. for 2 seconds to 10 minutes to obtain a shelf-stable fermented plant-based product.

After this heating step, the fermented plant-based product is cooled down to room temperature.

The fermented plant-based product preferably contains from 1 to 6% proteins, preferably from 1 to 3% protein, more preferably from 1.5 to 3% protein. In an alternative embodiment of the product according to the invention comprises 2.2 to 6% proteins. It also contains from 0.5 to 10%, preferably from 5 to 8% carbohydrates and from 1 to 6%, preferably 1 to 3% fat.

This plant-based beverage according to the invention was subjected to fermentation process with bacterial culture. The amount of used bacterial culture can be 0.005 to 0.2%. Alternatively, the amount of used bacterial culture can be 0.01% to 0.02%.

A fermented beverage composition according to the invention include analogues to dairy products, in particular drinkable yoghurt like beverages.

The fermented beverage product may also comprise one or more additives selected among the followings:
sweeteners such as sugar-based sweeteners like sucrose, invert syrup, fructose syrup, glucose syrup, maltodextrins; sugarless sweeteners in particular sugar alcohols such as maltitol, xylitol, sorbitol, erythritol, mannitol, isomaltose and lactitol, hydrogenated starch hydrolysates, saccharin, cyclamate, acesulfame, an L-aspartyl-based sweetener; combinations thereof.
flavours and/or colorants.
one or more vitamins and/or minerals, in particular vitamins A, B, C, D, E, K, ascorbic acid, ascorbyl palmitate, pantothenic acid, folic acid and biotin or a combination thereof; calcium, magnesium, iron, zinc, iodine, copper, phosphorus, manganese, potassium, chromium, molybdenum, selenium, nickel, tin, silicon, vanadium and boron or a combination thereof. The source of calcium can include calcium carbonate, calcium phosphate, calcium citrate, other insoluble calcium compounds. The sources of magnesium can include magnesium phosphate, magnesium carbonate, magnesium hydroxide. The sources of iron include iron ammonium phosphate, ferric pyrophosphate, ferric phosphate, ferrous phosphate, other insoluble iron compounds, amino acids, iron chelating compounds such as EDTA.
prebiotics; a “prebiotic” is to be understood as a non-digestible food ingredient that promotes the growth of beneficial microorganisms in the intestines. Non-limiting examples of prebiotics include fructooligosaccharides, inulin, lactulose, galactooligosaccharides, soyoligosaccharides, xylooligosaccharides, isomaltooligosaccharides, gentiooligosaccharides, lactosucrose, glucooligosaccharides, pectioligosaccharides, resistant starches, sugar alcohols or a combination thereof.
fibers, such as citrus fiber, polydextrose, cereal flour/bran/husk
one or more stabilizer systems. A “stabilizer system” is to be understood as an ingredient or a mixture of ingredients which contributes to the physical stability of the food product with respect to shelf life.
additional proteins from animal or vegetal origin

A source of protein food product according to the invention usually contains from 1 to 10%, preferably from 1 to 6% and more preferably from 2 to 4% weight proteins from an oleaginous plant (providing at least 12% of the energy value of the food product).

The source of protein product is subjected to the incubation with a bacteria culture with an addition of 0.01% to 0.02%, at 40-47° C., preferably from 42 to 45° C. The fermentation is stopped at a pH of 4.2-4.7, preferably from 4.2-4.5.

Optionally, the fermented product is subjected to another UHT heat treatment.

In another embodiment of the invention, no additional UHT heat treatment is applied.

The invention is further described with reference to the following examples. It will be appreciated that the invention as claimed is not intended to be limited in any way by these examples.

### Material and Methods

The materials and methods used to perform the following examples are described thereafter.

The detailed process for the preparation of the invention is shown in Error! Reference source not found.

Wholesome nuts and seeds, and roasted and/or milled products of thereof, legumes, bacterial cultures, grains (oat flour), hydrocolloids (pectin), antioxidant systems and other additives were obtained from different origins (e.g. unshelled walnut kernels from California, Chile and China as indicated in Table 4).

1) pH

The pH of the plant-based beverages was measured using a pH meter fitted with a glass electrode (SevenCompact pH/Ion S220, Mettler-Toledo AG, Switzerland). All measurements were carried out at 25° C.

### 2) Particle Size Distribution (PSD)

The PSD of the beverages was determined using a laser diffraction analyzer (MasterSizer 3000, Malvern Instruments Ltd., UK), applying the Fraunhofer optical model. Measurements were performed at room temperature using a refractive index of 1.5 and each sample was run in triplicate. Droplets of sample were slowly added into a sample compartment filled with distilled water until obscuration was 2.93%. The mean diameter was evaluated based on volume weighted mean diameter (d_{4,3}; Eq. (1)) and also cumulative percentiles were determined, d_{0,1}, d_{0,5} and d_{0,9}, indicating that 10%, 50% and 90% of the particles respectively were below the specified diameter.

$$d 4 , 3 = \frac{{\sum }_{i} {n}_{i} {d}_{i}^{4}}{{\sum }_{i} {n}_{i} {d}_{i}^{3}} \qquad ( 1 )$$

### 3) Moisture Analysis

Measured according to Karl Fischer's method.

### 4) Rheological Measurements

The viscosity of the beverages was analyzed using a HAAKE RheoStress 6000 (HAAKE Co., Germany) coupled with UMTC thermocontroler (Thermo Scientific, US). A stress ramp test was performed at 25° C. constant temperature for 180 sec and shear rate from 0 to 300 1/s; the data are collected every two seconds and the measuring gap was equal to 1 mm. Consistency coefficient and flow-behaviour index were defined by plotting the shear stress versus the shear rate (Eq. (2)); where T is shear stress (Pa), k is consistency coefficient in (Pas), ¿ is shear rate (1/s) and n is flow-behaviour index. The rheological results were monitored using a Rheo Win software.

$$τ = k * {γ}^{n} \qquad ( 2 )$$

### 5) Sensory Evaluation

Sensory characteristics were evaluated by observation and assessed organoleptically at the end of fermentation by a panel consisting of staff and students. Additionally, sensory monadic profiling evaluations were performed by 9 trained panelists on the fermented nut beverages at different time points during a 9-month shelf-life. Data obtained were compared with Duncan's multiple range test (significance p<0.05).

The beverages were evaluated using descriptors covering all product dimensions: appearance, odor, flavor, texture, and mouthfeel. Beverages were presented to the panel at each session, served at 4° C. (as reference), 25° C. and 37° C.

### 6) Accelerated Oxidation Test (Rapidoxy)

Nuts and seeds based fermented beverages (5 g) were weighted in a glass vial and oxidized by Rapidoxy (Anton Paar, Germany) at 7 bar at 80° C. Induction period (IP) is reported as time elapsed between starting of the analysis and formation of oxidation products yielding to a defined oxygen pressure drop of 10%. A maximum run time of 20 h (1200 min) was set. When sample reaches the maximum rum time, the oxygen pressure-drop (%) will be reported instead of IP (min).

### Examples

### Example 1: Effect of Lactic Acid Fermentation Substrate and Strain on the Sensory and Physical Properties of Fermented Plant-Based Beverages

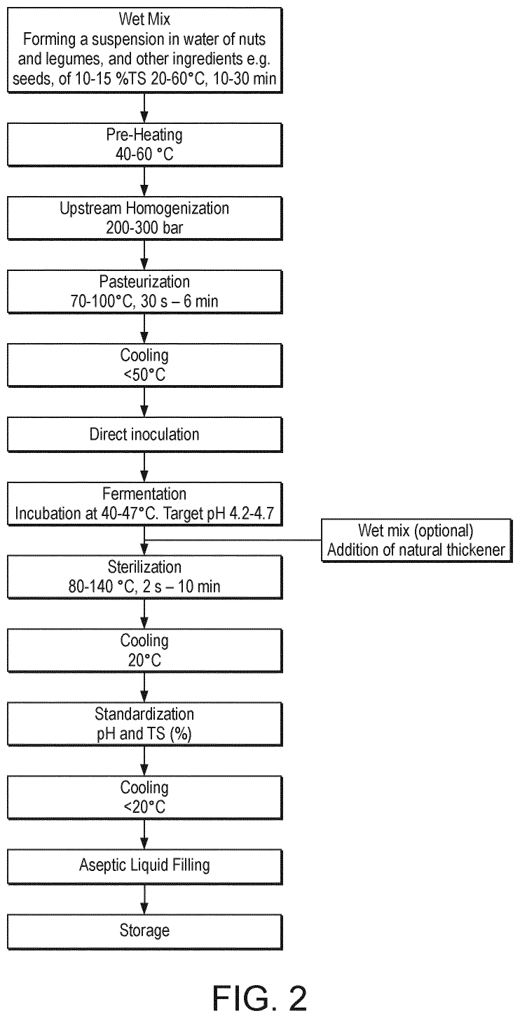

Fermented plant-based beverages were prepared as previously shown in FIG. 2 containing a single type, W (10-15% walnut), or a combination of nuts and seeds, WC-2 (10-15% walnut, 2-5% cashew nut), as well in combination with protein from legumes, such as pea protein, WP (10-15% walnut, pea protein 1-3%) and WCP (10-15% walnut, 2-5% cashew nut, 1-3% pea protein). The drinks were inoculated with different bacterial strains, containing a combination of lactic acid bacteria L. bulgaricus and S. thermophilus; or also in combination with L. plantarum, L. acidophilus and B. lactis.

Table 1 shows a summary of the sensory assessment of selected samples (n=8) evaluated at 4° C.

TABLE 1
Sensory evaluation of fermented plant-based beverages
with different lactic acid bacteria strains

| | | | | | | After |
|---|---|---|---|---|---|---|
| Product | Strain | Appearance | Odour | Flavour | Texture | sensations |
| W | L. bulgaricus, | Light grey | Walnut, | Walnut, fresh, | Powdery, | Walnut, oily, |
| | S. thermophilus | color, oily | fruity, | sweet, cereals, | coagulated, | slightly |
| | | | fermented | slightly acid, | aqueous | astringent |
| | | | | yoghurt | | |
| W | L. bulgaricus, | Light grey | Fermented, | Mild walnut | Powdery, | Astringency, |
| | S. Thermophilus, | color | mildly | note, sweet, | aqueous | sweet, |
| | L. Plantarum, | | walnut, | acid, yoghurt | | powdery, |
| | L. Acidophilus, | | slightly | | | acid |
| | B. Lactis | | oily | | | |
| WC-2 | L. bulgaricus, | Beige color, | Walnut, | More cashew, | Smoother, | |
| | S. thermophilus | smooth | cashew, | less walnut, | thicker, | |
| | | surface | fermented | sweet, more | mouth | |
| | | | | acid | coating | |
| WC-2 | L. bulgaricus, | Beige color | Walnut, | Strong cashew | Creamy, | Slightly |
| | S. Thermophilus, | | milk, | note, less | powdery | astringent, |
| | L. Plantarum, | | cereal, | walnut, sweet, | | cashew |
| | L. Acidophilus, | | roasted | | | |
| | B. Lactis | | | cereal, roasted | | |
| WCP | L. bulgaricus, | Beige color | Walnut, | Well- | Smooth, | Less |
| | S. thermophilus | | fresh, | balanced, | slightly | powdery |
| | | | fermented, | nuts, sweet, | creamy | |
| | | | cereal | slight pea note | | |
| WCP | L. bulgaricus, | Beige color, | Walnut, | Cashew, slight | Not | Astringent |
| | S. Thermophilus, | smooth | fresh, | pea note, | smooth, | |
| | L. Plantarum, | surface | fermented, | sweet, acid, | slightly | |
| | L. Acidophilus, | | cooked | yoghurt | creamy, | |
| | B. Lactis | | | | powdery | |
| WP | L. bulgaricus, | Light beige, | Walnut, | Nuts, roasted, | Smooth, | Sweet, less |
| | S. thermophilus | grey color, | pea | cereal | creamy | acid |
| | | smooth | | | | |
| | | surface | | | | |
| WP | L. bulgaricus, | Beige, grey, | Acid, | Acid | Powdery, | Ropy, |
| | S. Thermophilus, | smooth | fermented | | coagulated | astringent |
| | L. Plantarum, | surface | | | | |
| | L. Acidophilus, | | | | | |
| | B. Lactis | | | | | |

It was observed that each combination of bacterial strains acidifies the media reinforcing the texture of the emulsion and generates different aromatic molecules, while masking off-flavours.

It was surprisingly found that when a combination of strains L. bulgaricus and S. thermophilus were used as fermentation starters, the resulting beverages had positive sensorial attributes such as nutty, cereal and acidic flavor, and smooth, creamy texture. In contrast, when fermentation was carried out with also a combination of L. plantarum, L. acidophilus and B. lactis, the beverages had more negative attributes, such as cooked and oily flavor, powdery and aqueous texture, and astringent mouthfeel.

Also, it was found that there was a tendency of liking when the fermented beverages contained at least a combination of nuts, or also comprised proteins from legumes (WP and WCP), as they were perceived as creamier in texture and with enhanced nutty and cereal notes in flavour (Table 1). A summary of results of physical properties analysed in the beverages is shown in Table 2.

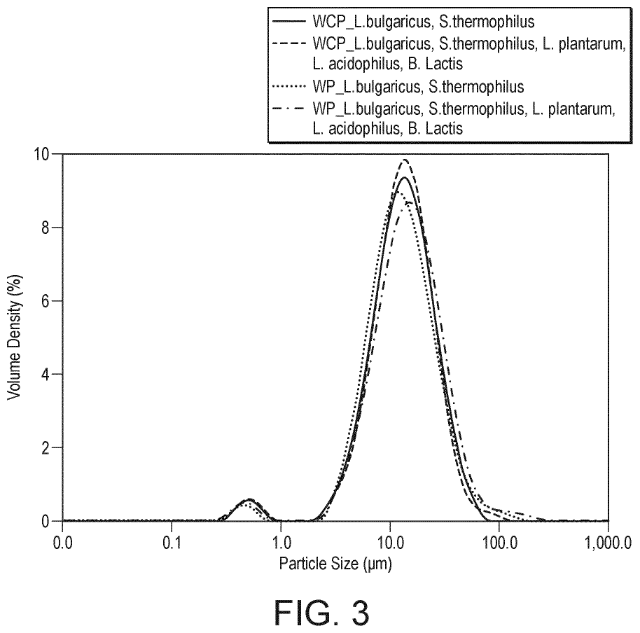

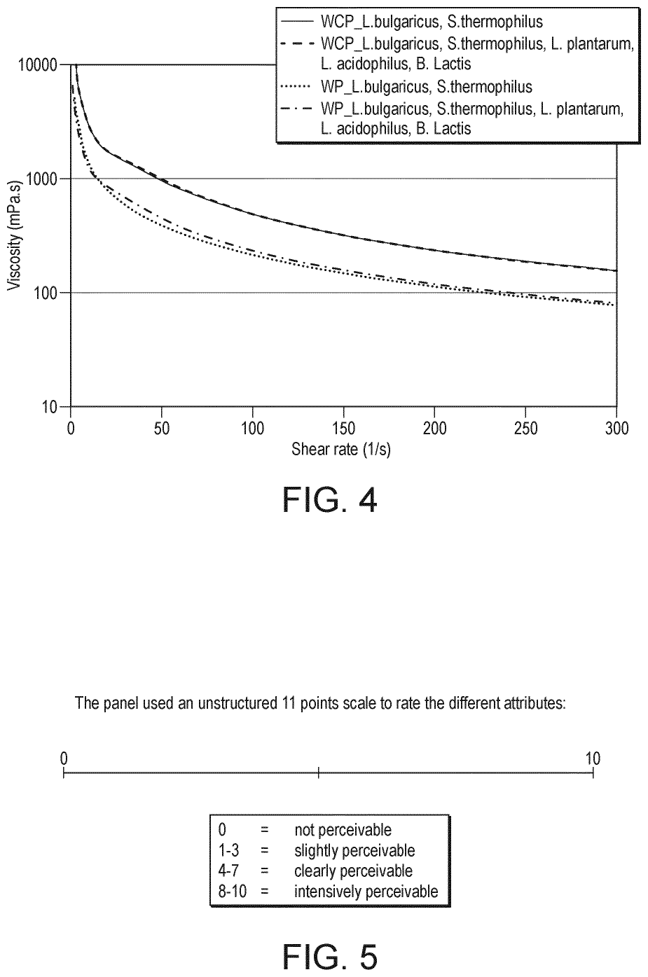

The combination of nuts, and more specifically nuts with higher starch content (5-12%) such as cashew nuts, enhances the creamy texture and mouthfeel due to starch gelatinization and subsequent increased viscosity, while particle size did not differ greatly (Table 2 and FIGS. 3, 4).

TABLE 2
PSD and viscosity parameters of selected plant-based
beverages fermented with different bacterial strains

| | | PSD | | Viscosity | | |
|---|---|---|---|---|---|---|
| | | D[4,3] | D90 | (mPas at 25° C.) | | |
| Product | Strain | (μm) | (μm) | 100/s | 200/s | 300/s |
| WP | L. bulgaricus, S. thermophilus | 15.5 | 29.3 | 213.1 | 112.3 | 77.42 |
| WP | L. bulgaricus, S. Thermophilus, | 15.5 | 28 | 235.9 | 119.4 | 80.67 |
| | L. Plantarum, L. Acidophilus, | | | | | |
| | B. Lactis | | | | | |
| WCP | L. bulgaricus, S. thermophilus | 16.1 | 30.2 | 493.2 | 238.2 | 157.3 |
| WCP | L. bulgaricus, S. Thermophilus, | 18.9 | 34.8 | 495.2 | 235.4 | 154.6 |
| | L. Plantarum, L. Acidophilus, | | | | | |
| | B. Lactis | | | | | |

### Example 2: Effect of Addition of Different Legumes on the Sensory Properties of Fermented Plant-Based Beverages

Fermented beverages were prepared containing only a combination of nuts or also in combination with different protein ingredients from legumes, such as isolates or concentrates, more specifically chickpea and soybean.

A sensory monadic profiling was performed with a trained panel, evaluating the drinks based on descriptors of appearance, flavour, texture, and mouthfeel on a 11-points scale without repetition (quantitative descriptive analysis) (FIG. 5).

It was surprisingly found that a combination of nuts, or nuts and protein from soybean, enhanced the nutty, cereal and acid flavour attributes, while reducing the perceived off-notes and having a similar creamy and mouth-coating texture in the fermented drinks. On the contrary, a combination of nuts and protein from chickpea, resulted in increased thickness and perceived off-notes as well as astringent mouthfeel.

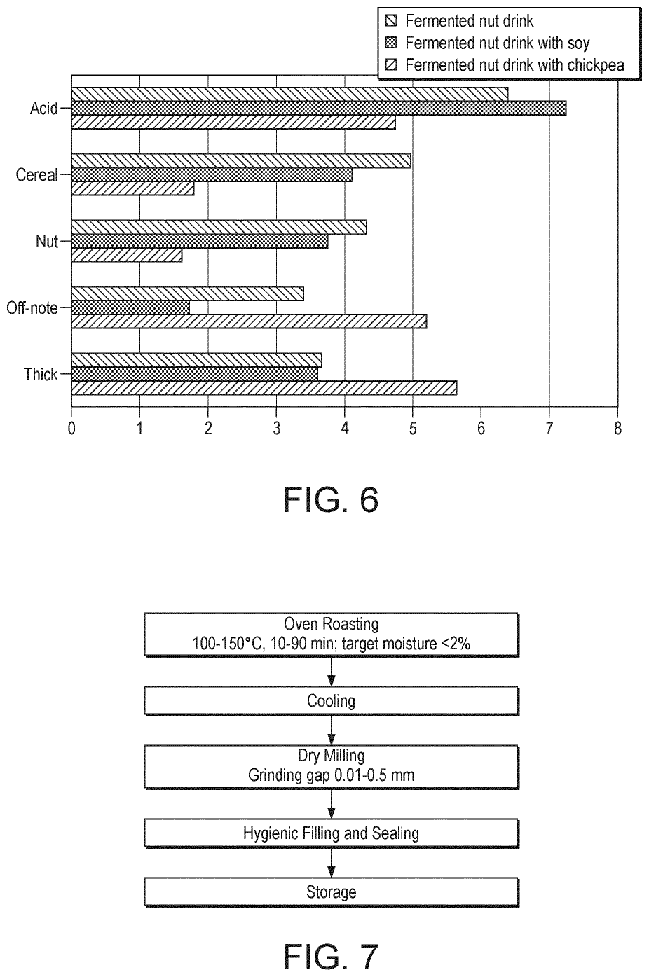

A combination of nuts and protein from soybean were found to have enhanced acid taste and reduced flavour off-notes while maintaining a similar flavour profile and texture in comparison with a fermented drink only containing nuts (Table 3 and FIG. 6).

TABLE 3
Sensory evaluation of fermented plant-based beverages containing
different proteins from legumes

| | | | | | After |
|---|---|---|---|---|---|
| Product | Appearance | Odour | Flavour | Texture | Sensation |
| Fermented nut- | Beige, grey | Fresh nuts, | Sour, sl. Sweet, | Mouth-coating | Slightly sour |
| based beverage | | green | green, nuts, | | |
| | | | walnut, fresh, | | |
| | | | roasted | | |
| Fermented nut- | Beige, yellow | Less nutty, | Sl. Sour, sl. | Thick, mouth- | Astringent |
| based beverage | | sl. | Sweet, vegetable | coating, | |
| with chickpea | | Vegetable | fat, nuts | powdery | |
| | | oil | | | |
| Fermented nut- | Beige, yellow | Nuts | Sl. Sour, sl. | Mouth-coating, | |
| based beverage | | | Sweet, nuts | creamy | |
| with soy | | | | | |

### Example 3: Process Optimization for the Preparation of Fermented Plant-Based Beverages by Milling and Homogenization

The impact of different degrees of roasting and milling conditions of nuts on the organoleptic properties of the pastes was assessed; FIG. 7 shows an embodiment of the process used for this evaluation.

Unshelled walnut kernels were roasted in the oven at selected conditions of temperature and time, as shown in Table 4, to reduce the moisture of the kernels below 2% for further dry milling in a colloid mill operating on the principle of rotor-stator, and using a grinding gap range from 0.02 to 0.5 mm. The obtained roasted nut paste could be then held at 4° C. until further application into the preparation of a nut drink.

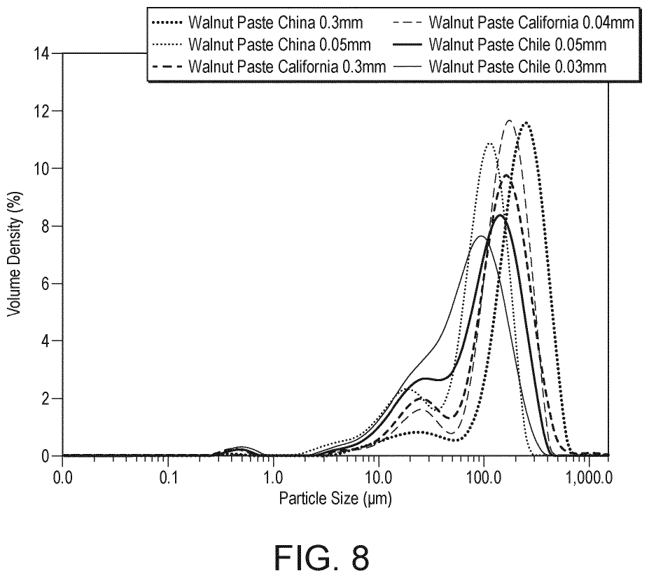

It has been observed that higher roasting temperatures resulted in a higher drying rate. At constant grinding gaps, 0.3 mm and 0.05 mm, higher temperatures and shorter time of roasting (120° C., 30 min) reduced similarly the moisture content of the kernels as lower temperatures and longer time (100° C., 10 min), however the latter further decreased the particle size of the paste. A change in the grinding gap from 0.3 mm to 0.05 mm did not reduce considerably the particle size in the paste roasted at 100° C. for 1 h, as observed for other conditions (Table 4 and FIG. 8).

It was surprisingly found that a combination of two-step roasting process (100° C., 1 h and 120° C., 10 min) and smaller grinding gap (<0.05 mm) was optimal for reducing moisture and particle size, while generating desired flavours (FIG. 8). Temperatures above 100° C. are required for the development of typical roasted nutty flavours; furthermore, an average particle size (d_{4,3}) around 50 μm was preferred for a smooth texture and mouthfeel of the final fermented nut beverage product (Table 4).

TABLE 4
Effect of roasting and grinding conditions on the moisture and PSD
parameters of a nut paste from unshelled walnut kernels

| | | Grinding | Moisture | PSD | |
|---|---|---|---|---|---|
| | | gap | | D[4;3] | D90 |
| Raw material | Roasting conditions | (mm) | (%) | (μm) | (μm) |
| Walnut kernel China | 120° C., 30 min | 0.3 | 1.5 | 227 | 394 |
| Walnut kernel China | 120° C., 30 min | 0.05 | 1.4 | 168 | 303 |
| Walnut kernel California | 100° C., 1 h | 0.3 | 1.5 | 154 | 287 |
| Walnut kernel California | 100° C., 1 h | 0.05 | 1.4 | 156 | 272 |
| Walnut kernel Chile | 100° C., 1 h; 120° C., 10 | 0.05 | 1.5 | 112 | 227 |
| | min | | | | |
| Walnut kernel Chile | 100° C., 1 h; 120° C., 10 | 0.03 | 1.3 | 68.3 | 139 |
| | min | | | | |

The table shows the effect of homogenization pressure in the viscosity of the final product in selected recipes. Homogenization was carried out at 60-75° C. using a range of pressures, at one and two-stages, of 50-500 bar.

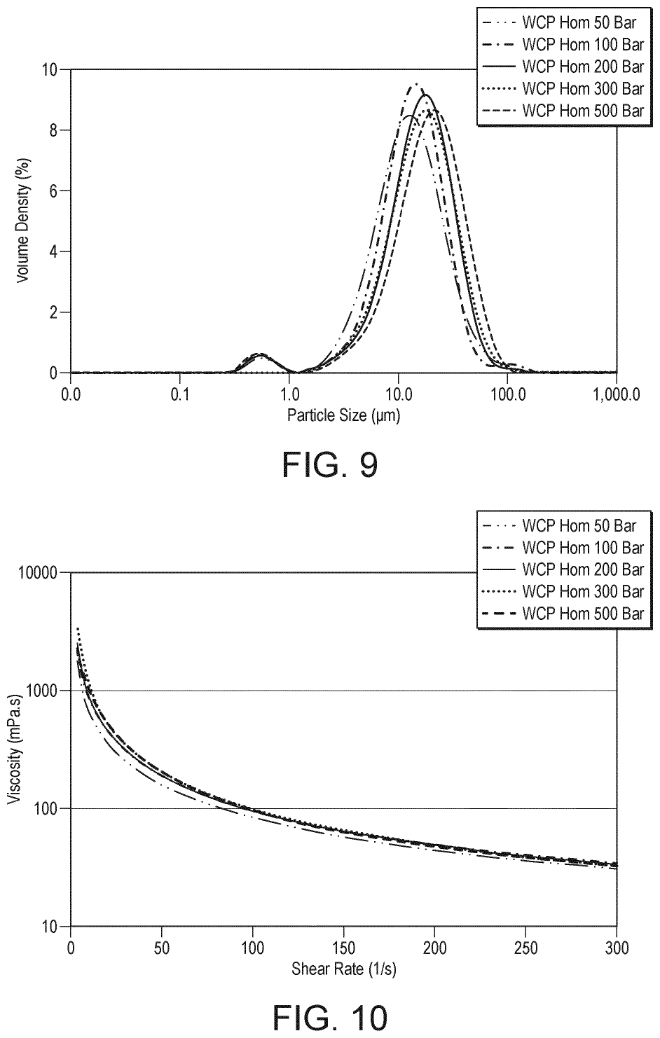

As shown in Table 5, in an emulsion containing a mix of nuts and legumes (WCP), particle size increased directly proportional to the higher homogenization pressure (FIG. 9), whereas viscosity increased when pressures from 50 bar to 200 bar were used and slightly decreased when homogenization was carried out at 300-500 bar (FIG. 10).

Homogenization leads to increase in viscosity due to starch gelatinization and protein aggregation, forming a network with protein-oil droplet aggregates entrapping water and causing a thickening effect. At higher homogenization pressures, a decrease in viscosity can occur due to the formation of larger oil droplets and disruption of the network (Table 5 and FIGS. 9, 10).

It was surprisingly found that a homogenization pressure of 200 bar, consisting of two-stage pressures of 50 and 150 bar, was an ideal combination for the texture optimization of the plant-based beverages.

TABLE 5
Effect homogenization pressure on the PSD and viscosity
parameters of a fermented plant-based beverage

| | PSD | | | | |
|---|---|---|---|---|---|
| Homogenization | D[4,3] | D90 | Viscosity (mPas at 25° C.) | | |
| pressure (bar) | (μm) | (μm) | 100/s | 200/s | 300/s |
| 50 | 30.8 | 16 | 84.21 | 44.12 | 30.88 |
| 100 | 29.7 | 16.7 | 94.39 | 48.74 | 33.76 |
| 200 | 35.3 | 19 | 94.5 | 48.65 | 33.72 |
| 300 | 37.8 | 19.7 | 95.88 | 47.77 | 32.95 |
| 500 | 43.8 | 22.6 | 96.38 | 47.84 | 32.79 |

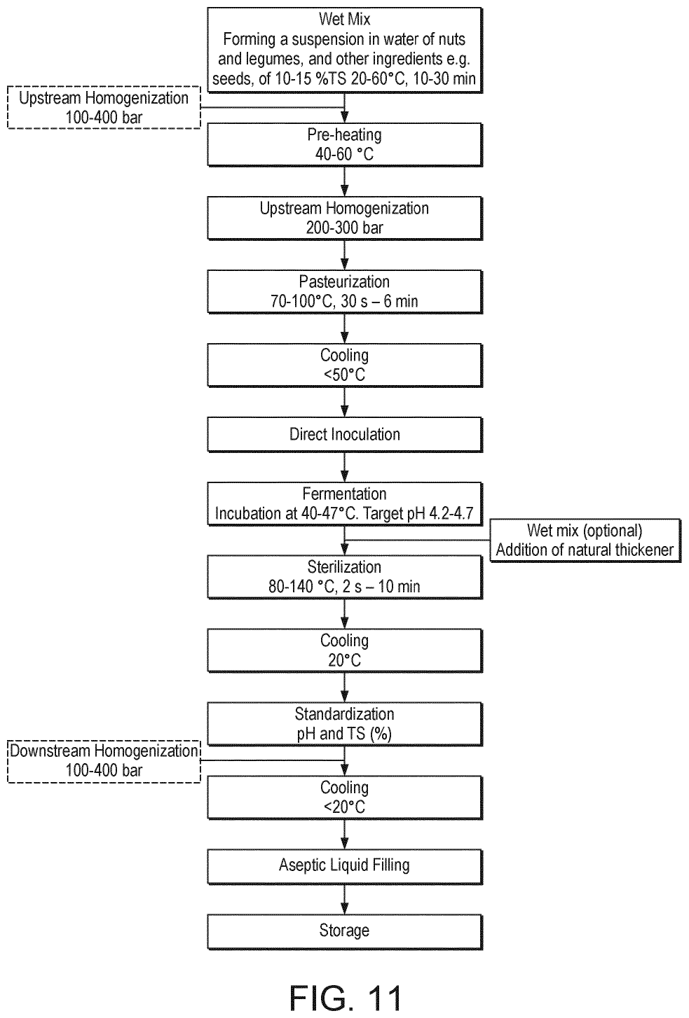

Roasted nuts and seeds pastes have been further used for the preparation of fermented nut beverages in various combinations, such as: walnut (1-5%) with cashew (0.5-2%) (WC), hazelnut (1-5%) with almond (3-7%) (HA), ablack sesame (0.5-5%) with almond (1-5%) (BS), and walnut (1-6%) with almond. Additionally, the drinks contained other ingredients such as sugar (2-5%), grains as oat flour (1-5%), legumes protein as pea protein (0.2-3%), and soluble fibers (0.2-3%). The drinks were inoculated with the selected combination of lactic acid bacteria L. bulgaricus and S. thermophilus and processed as shown in FIG. 11.

Table 5 shows different process steps of homogenization, having one single step or two steps before the thermal treatments (1-step upstream homogenization and 2 step upstream homogenization, respectively), or one homogenization step before pasteurization and one step after the sterilization of the fermented beverages.

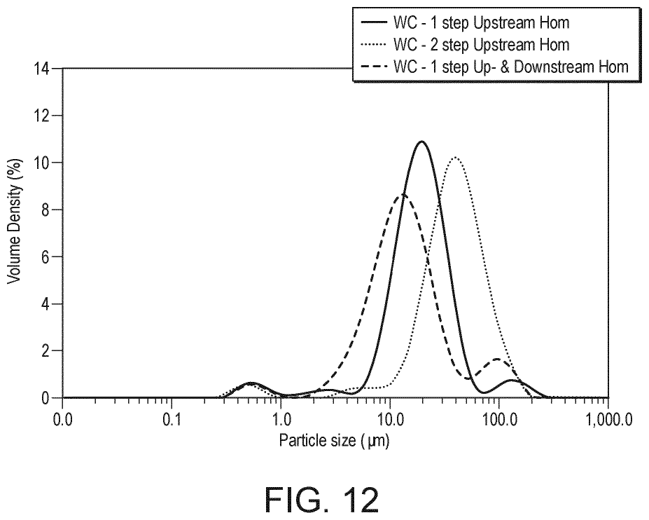

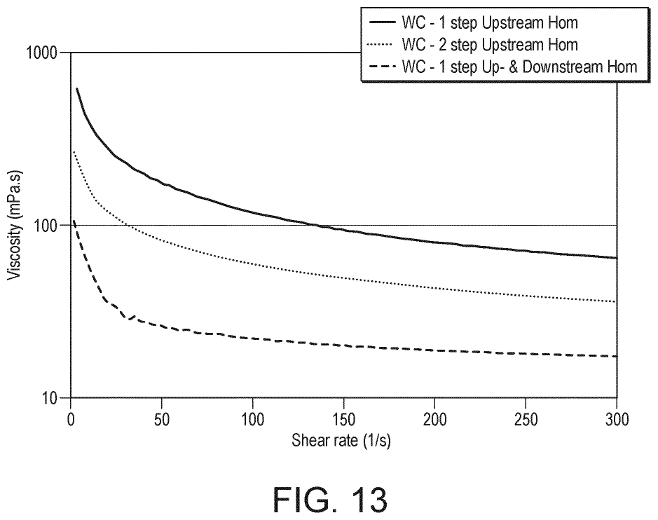

As shown in Table 6, one step of upstream homogenization before the thermal treatments resulted in a higher viscosity in all different beverages due to the starch gelatinization and protein aggregation having a texture-yielding effect; while the particle size was similarly maintained being the average (d_{4,3}) particle size below 50 μm (FIG. 12). On the contrary, the other processing conditions lead to a greater decrease in viscosity (FIG. 13) due to larger aggregation of particles and consequent disruption of the network.

TABLE 6
Effect of different homogenization conditions on the PSD
and viscosity parameters of fermented plant-based beverage

| | PSD | | | | |
|---|---|---|---|---|---|
| | D [4;3] | D90 | Viscosity (mPas at 25° C.) | | |
| Product | (μm) | (μm) | 100 (1/s) | 200 (1/s) | 300 (1/s) |
| WC-1 step Upstream | 26.1 | 45.3 | 118.8 | 80.04 | 64.95 |
| Homogenization | | | | | |
| WC-2 step Upstream | 44.9 | 82.7 | 22.12 | 21.86 | 17.43 |
| Homogenization | | | | | |
| WC-1 step Upstream & | 22.3 | 49.5 | 59.78 | 43.35 | 36.19 |
| Downstream | | | | | |
| Homogenization | | | | | |
| HA-1 step Upstream | 36.5 | 52.4 | 277.8 | 170.2 | 130.1 |
| Homogenization | | | | | |
| HA-2 step Upstream | 43.1 | 74.8 | 21.38 | 18.85 | 17.2 |
| Homogenization | | | | | |
| HA-1 step Upstream & | 20.3 | 32.5 | 25.69 | 19.75 | 17.39 |
| Downstream | | | | | |
| BS-1 step Upstream | 50.5 | 59 | 178.8 | 104.8 | 81.12 |
| Homogenization | | | | | |
| BS-2 step Upstream | 34.5 | 55 | 25.09 | 19.69 | 17.55 |
| Homogenization | | | | | |
| BS-1 step Upstream & | 15.3 | 24.1 | 34.07 | 26.24 | 22.72 |
| Downstream | | | | | |
| Homogenization | | | | | |

It was surprisingly found that using one single step of homogenization upstream before thermal treatments resulted in beverages with creamy and smooth texture, whereas the other processing conditions resulted in beverages with undesired aqueous and powdery texture, also unmasking after sensations such as bitterness and astringency owing to the decrease in viscosity and the interaction of particles in the mouth (Table 7).

TABLE 7
Sensory evaluation of fermented plant-based beverages processed with
different homogenization conditions

| | | | | | After |
|---|---|---|---|---|---|
| Product | Appearance | Odour | Flavour | Texture | Sensations |
| WC-1 step | Beige | Walnut | Nuts, cereal, acid | Creamy, thick, | Pea notes |
| Upstream | | | | smooth | |
| Homogenization | | | | | |
| WC-2 step | Beige | Walnut | Nuts, acid | Powdery, more | |
| Upstream | | | | granular | |
| Homogenization | | | | | |
| WC-1 step | Beige | Yoghurt, | Fresh, nuts, | Creamy | Bitter |
| Upstream & | | walnut | sweet, oat, pea | | |
| Downstream | | | | | |
| Homogenization | | | | | |
| HA-1 step | Dark beige | Hazelnut, | Nuts, more | Thick, creamy | Cereal, |
| Upstream | | cereal | complex, 24es | | slightly |
| Homogenization | | | acid | | astringent |
| HA-2 step | Beige | Hazelnut | More hazelnut | More aqueous, | |
| Upstream | | | notes | less powdery | |
| Homogenization | | | | | |
| HA-1 step | Beige | Hazelnut | Hazelnut, cereal, | More creamy | Bitter |
| Upstream & | | | acid | | |
| Downstream | | | | | |
| BS-1 step | Grey | Nuts, | Nuts, fresh | Slightly | Nuts, |
| Upstream | | roasted | | powdery | sweet |
| Homogenization | | | | | |
| BS-2 step | Grey | Mild | Sesame, acid | More aqueous | |
| Upstream | | sesame | | | |
| Homogenization | | notes | | | |
| BS-1 step | Grey | Mild | Sesame, sweet, | Watery | Bitter, |
| Upstream & | | sesame | acid, balanced | | astringent |
| Downstream | | notes | | | |
| Homogenization | | | | | |

### Example 4: Screening of Natural Antioxidants in Fermented Plant-Based Beverages with Accelerated Oxidation Stability Measurement with Pressurized Oxygen

Nuts and seeds are prone to oxidation due to high unsaturated fatty acid content, such as walnuts being rich in omega-3 fatty acids. The oxidative stability of nuts and seeds-based products can be improved by addition of natural antioxidant systems.

Fermented nut beverages containing various combinations of roasted nuts and seeds pastes (WC, HA, BS) were subjected to an accelerated oxidation test, with and without addition of various oil-soluble and water-soluble antioxidants, such as tocopherol mixes, Toco mix-1 (70% tocopherols blend) and Toco mix-2 (50% tocopherols blend), and extracts containing green tea (GT) or rosmarinic acid (RA).

It was surprisingly found, that all evaluated natural antioxidants improved the oxidative stability of the fermented plant-based beverages. A fermented plant-based beverage containing a combination of walnut and cashew nut (WC), had the lowest oxidative stability without addition of natural antioxidants (WC Ref) as indicated by the highest percentage of oxygen pressure drop after 20 h at 80° C. measure by RapidOxy (FIG. 14).

The fermented plant-based beverages (WC) with selected antioxidants were evaluated by a sensory monadic profiling with a trained panel, using a 6-point scale (FIG. 15) to rate the Degree of Difference (DoD) between the products at different storage conditions based on appearance and absence of off-flavours and astringency.

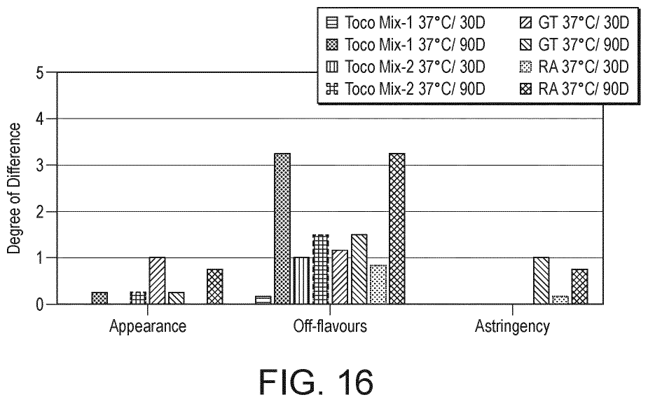

FIG. 16 shows a representation of the sensory monadic profiling results of products evaluated after 30 and 90 days of storage at 37° C. Toco-mix 1 and RA had the highest rated DoD after 90 days regarding off-flavour attributes, indicating a higher perception of rancid and painty flavours typical from oil oxidation. Toco mix-2 and GT had a similar performance in improving the oxidative stability of the drink with only slight differences in off-flavours between 30 and 90 days; however, GT had more differences in appearance already at 30 days and perceived astringency at 90 days in comparison.

It was surprisingly concluded from the results of both the accelerated oxidation test and sensory evaluation, that Toco mix-2 had the best performance in improving the oxidative stability of the fermented plant-based beverages, while maintaining their physical stability during 9-month shelf life at 4, 25 and 37° C.

1. A fermented plant-based beverage composition comprising nuts and legumes,
the nuts and legumes present 25 to 50 wt. % of the total solids in the beverage composition,
at least 50 wt. % of the nuts are roasted, and
at least 50 wt. % of the nuts, and wherein
the beverage composition being fermented with strains comprising lactic acid bacteria 1) Lactobacillus delbrueckii subsp. bulgaricus and 2) Streptococcus thermophilus, and having a pH of 4.0 to 5.5, preferably a pH of 4.2-4.5.

2. A fermented beverage composition according to claim 1, comprising 5-20 wt. % total solids (TS).

3. A fermented beverage composition according to claim 1, wherein the fermented beverage composition comprises 0.5-3 wt. % legumes.

4. A fermented beverage composition according to claim 1, wherein the legumes are selected from the group consisting of pea, soy, faba, chickpea and a combination thereof, wherein the legumes are preferably in the form of protein isolates or concentrates.

5. A fermented beverage composition according to claim 1, wherein nuts are present in amounts of 1 to 6 wt. %.

6. A fermented beverage composition according to claim 1, comprising 0.5-5 wt. % seeds.

7. A fermented beverage composition according to claim 1, comprising 0.5-5 wt. % cereal.

8. A fermented beverage composition according to claim 1, comprising 0.2-5 wt. % dietary fiber.

9. A fermented beverage composition according to claim 1, wherein the beverage composition comprises 2-6 wt. % added sugar.

10. A process for preparing a fermented plant-based beverage composition, the process comprises the steps:
a) providing nuts and legume, wherein at least 50 wt. % of the nuts and optionally seeds are wholesome nuts and seeds, and
b) roasting at least 50 wt. % of the nuts to a moisture content below 2 wt. % water,
c) reducing particles size of the nuts and optionally seeds to a resultant particle size below 70 microns,
d) forming a suspension with 10-15 total solids (TS) % comprising the nuts,
e) homogenizing the suspension at a pressure 100-300 bar,
f) heat treating the suspension at a temperature of 70 to 100° C. for a period 30 sec to 6 min,
g) inoculating the beverage composition with strains comprising lactic acid bacteria 1) Lactobacillus delbrueckii subsp. bulgaricus and 2) Streptococcus thermophilus, and
2) fermenting the beverage composition until reaching a pH from 4.0 to 5.5.

11. Process for preparing fermented beverage composition according to claim 10, wherein the homogenization in step e) is a one-step homogenisation.

12. A process for preparing a fermented beverage according to claim 10, wherein, after step d) an additional heating is carried out at a temperature from 80° C. to 140° C. for 2 seconds to 10 minutes to obtain a shelf-stable fermented nuts and seeds-based beverage.

13. A process according to claim 10, wherein the starter culture comprises additional lactic acid-producing bacteria or the starter culture comprises least one lactic acid-producing bacteria.

14. (canceled)
